(19) United States
(12) Patent Application Publication
(10) Pub. No.: US 2017/0279915 A1
(43) Pub. Date: Sep. 28, 2017

(54) SWITCH ACCESS MODULE, CELL ENCAPSULATION METHOD, SWITCHING NETWORK SYSTEM AND COMPUTER STORAGE MEDIUM

(71) Applicant: ZHONGXING MICROELECTRONICS TECHNOLOGY CO., LTD, Shenzhen, Guangdong (CN)

(72) Inventors: Min Zeng, Shenzhen (CN); Zhiqiang He, Shenzhen (CN); Fengming Xu, Shenzhen (CN); Minda Kong, Shenzhen (CN)

(21) Appl. No.: 15/506,370

(22) PCT Filed: Mar. 16, 2015
(86) PCT No.: PCT/CN2015/074334

§ 371 Date: Feb. 24, 2017

(30) Foreign Application Priority Data
Aug. 25, 2014 (CN) 201410422531.X

(51) Int. Cl. H04L 29/08; H04L 29/06; H04L 12/815; H04L 12/823; H04Q 11/04; H04L 12/54

(52) U.S. Cl. CPC H04L 67/2842; H04Q 11/0478; H04L 12/56; H04L 47/22; H04L 47/32; H04L 12/54; H04L 29/06

(57) ABSTRACT

A switch access module, a cell encapsulation method, a switching network system and a computer storage medium are described. The method includes that: the switch access module determines accumulated unsent data corresponding to a destination address according to the destination address of a received data packet, the accumulated unsent data corresponding to the destination address including the data packet received by the switch access module and unsent data cached by the switch access module and corresponding to the destination address; and the accumulated unsent data corresponding to the destination address is filled into at least one cell according to a preset cell minimum length and a length of the accumulated unsent data corresponding to the destination address.

### TECHNICAL FIELD

The disclosure relates to a communication technology, and more particularly, to a switch access module in a switching network system, a cell encapsulation method, the switching network system and a computer storage medium.

### BACKGROUND

In a network system, a data switching architecture in a router or a switch mainly consists of line cards and a switch fabric. As shown in FIG. 1, the line cards are mainly provided with interface modules, packet processor modules and switch access modules, wherein the interface modules may be Synchronous Digital Hierarchy (SDH) framers or Ethernet physical layer and link layer chips, and the packet processor modules are Network Processors (NPs) or Field Programmable Gate Array (FPGA)-based packet processors. After data packets enter the line card from the interface modules, the interface modules discard wrong data packets therein and transmit correct data packets to the packet processor modules for processing, and the packet processor modules perform analysis processing on the data packets to obtain destination switch access modules (i.e. the switch access modules to which the data packets are intended to be sent) of the data packets and flow numbers of the data packets according to information such as destination addresses (destination Media Access Control (MAC) or destination Internet Protocol (IP)), service types and priorities of the data packets, and then send the data packets to the switch access modules. The switch access modules encapsulate the data packets into cells according to the destination addresses of the data packets, and transmit the cells to the switch fabric, and the cells are forwarded to switch access modules corresponding to the destination addresses through the local switch fabric.

Switch access modules and switch fabrics of multiple routers or switches form a switching network. As shown in FIG. 2, interconnection between the switch access modules and the switch fabrics is usually implemented by virtue of high-speed serial links. In the switching network, there exist various data flows, such as various data flows with different source addresses (from different switch access modules) and different destination addresses (required to be switched to different switch access modules), wherein the data flows further include unicast data (divided into unicast cells for transmission to the switch fabrics by the switch access modules) and multicast data (divided into multicast cells for transmission to the switch fabrics by the switch access modules), each unicast cell is required to be sent to only one destination switch access module, and the multicast cells are required to be copied in the switch fabrics, and then are sent to different switch access modules. Usually, whether the data flows are unicast or multicast, unicast destination addresses and multicast Identities (IDs) are all notified to the switch access modules by packet processor modules.

When processing unicast cells, a switch fabric is required to forward the unicast cells from different switch access modules according to their destination addresses. The switch fabric usually stores the unicast cells from different switch access modules in a cache, then reads the unicast cells in the cache, searches for high-speed serial links capable of reaching destination switch access modules according to the destination addresses in the cells, stores the unicast cells into caches of the corresponding high-speed serial links, and finally sends the unicast cells to the destination switch access modules through the high-speed serial links.

When processing multicast cells, the switch fabric is required to forward the multicast cells from different switch access modules according to multicast IDs in the cells. The switch fabric usually stores the multicast cells from different switch access modules in the cache, then reads the multicast cells in the cache, searches for switch access modules to which the multicast cells are required to be sent according to the multicast IDs of the cells, searches for a high-speed serial link capable of reaching each destination switch access module according to numbers of multiple switch access modules to which the cells are required to be sent, copies and stores the multicast cells into caches of the corresponding high-speed serial links, and finally sends the multicast cells to the destination switch access modules through the high-speed serial links.

Along with development of a switching network system, a requirement on a processing capability of a switching network increases, which requires a switch fabric to process a large number of cells per second and makes a higher design requirement on a searching capability and cache reading-writing capability of the switch fabric, so that it is difficult to design and implement the switch fabric.

### SUMMARY

Embodiments of the disclosure provide a switch access module, a cell encapsulation method, a switching network system and a computer storage medium, which can reduce a number of cells sent from the switch access module to a switch fabric and further reduce a cell forwarding rate of the switch fabric.

Technical solutions of embodiments of the disclosure are implemented as follows.

An embodiment of the disclosure provides a cell encapsulation method, which includes that:

a switch access module determines accumulated unsent data corresponding to a destination address according to the destination address of a received data packet, wherein the accumulated unsent data corresponding to the destination address contains the data packet received by the switch access module and unsent data cached by the switch access module and corresponding to the destination address; and

the accumulated unsent data corresponding to the destination address is filled into at least one cell according to a preset cell minimum length and a length of the accumulated unsent data corresponding to the destination address.

An embodiment of the disclosure further provides a switch access module, which includes:

a caching unit, arranged to cache unsent data;

a determination unit, arranged to determine accumulated unsent data corresponding to a destination address according to the destination address of a received data packet, wherein the accumulated unsent data corresponding to the destination address contains the data packet received by the switch access module and unsent data cached by the caching unit and corresponding to the destination address; and

an encapsulation unit, arranged to fill the accumulated unsent data corresponding to the destination address into at least one cell according to a preset cell minimum length and a length of the accumulated unsent data corresponding to the destination address.

An embodiment of the disclosure further provides a switching network system, which includes switch access modules and switch fabrics, wherein

each switch access module is arranged to determine accumulated unsent data corresponding to a destination address according to the destination address of a received data packet, wherein the accumulated unsent data corresponding to the destination address contains the data packet received by the switch access module and unsent data cached by the switch access module and corresponding to the destination address; and

each switch access module is arranged to fill the accumulated unsent data corresponding to the destination address into at least one cell according to a preset cell minimum length and a length of the accumulated unsent data corresponding to the destination address.

An embodiment of the disclosure further provides a computer storage medium, in which a computer-executable instruction may be stored, the computer-executable instruction being arranged to perform the abovementioned cell encapsulation method.

In embodiments of the disclosure, the switch access module may fill multiple data packets corresponding to the accumulated unsent data corresponding to the destination address into the at least one cell, and the condition of always filling one data packet into one cell in a related technology is avoided, so that the number of the cells sent to the switch fabric is reduced, the cell forwarding rate of the switch fabric is further reduced, and difficulties in designing of the switch fabric are reduced.

### BRIEF DESCRIPTION OF THE DRAWINGS

FIG. 1 is a universal data switching architecture in a switching network system;

FIG. 2 is an architecture diagram of a switching network system;

FIG. 3 is a flow chart of a cell encapsulation method according to an embodiment of the disclosure;

FIG. 4 is an implementation flow chart of cell encapsulation processing in case of reception of different data packets according to an embodiment of the disclosure;

FIG. 5 is an implementation flow chart of cell encapsulation in a scenario 1 according to an embodiment of the disclosure;

FIG. 6 is an implementation flow chart of cell encapsulation in a scenario 2 according to an embodiment of the disclosure;

FIG. 7 is a structure diagram of a switch access module according to an embodiment of the disclosure; and

FIG. 8 is an architecture diagram of a switching network system according to an embodiment of the disclosure.

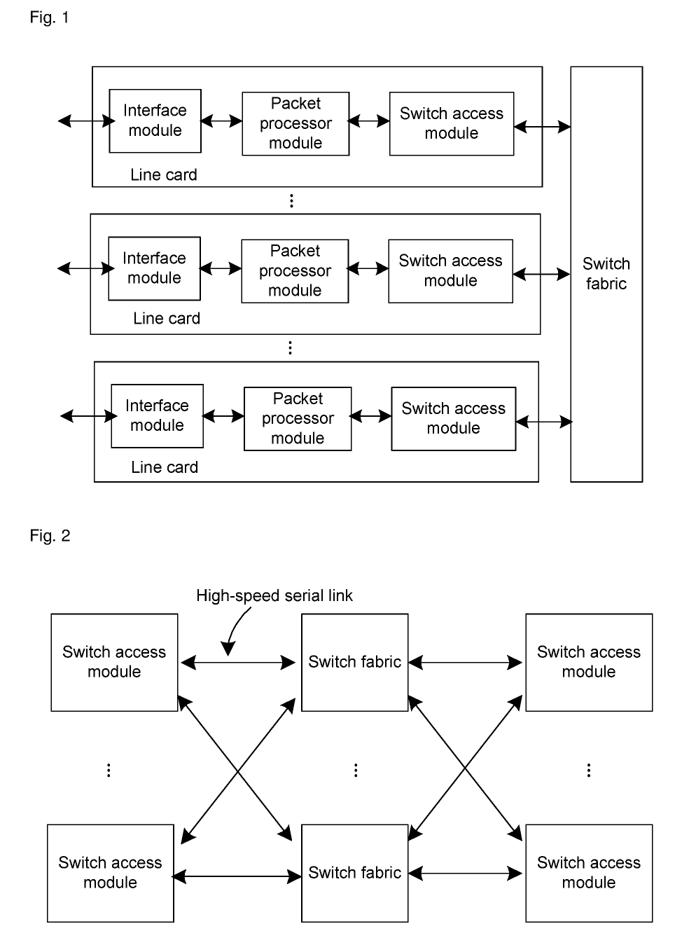

### DETAILED DESCRIPTION

In order to make a purpose, technical solutions and advantages of the disclosure clearer, the disclosure will be further described below with reference to the drawings and embodiments in detail. It should be understood that the specific embodiments described here are only adopted to explain the disclosure and not intended to limit the disclosure.

The technical solutions of the disclosure will be described below with reference to the drawings and the embodiments in detail.

The inventor finds in a process of implementing the disclosure that: in an existing switching network system, when a switch access module encapsulates data packets into cells, a payload of each cell only stores one data packet, that is, there may not be two or more data packets in the payload of one same cell. Along with increase of a requirement on a processing capability of a switching network, a processing capability of an interface module is developed from rates 1 Gbps and 10 Gbps to present 100 Gbs and 400 Gbps, and similarly, processing capabilities of a packet processor module and the switch access module are also increased to 100 Gbps and 400 Gbps. Meanwhile, a minimum data packet length required to be processed in the switching network system is not increased, so that a forwarding rate of a minimum data packet (corresponding to a cell, one cell being encapsulated with one data packet) required to be processed by the switch access module is greatly increased. Here, the forwarding rate refers to a number of minimum data packets (corresponding to cells) required to be processed per second. It is set that a minimum data packet of an Ethernet interface is 64 bytes, a 64-byte fixed length packet forwarding rate of 10 G Ethernet within 1 second is 15M, and when a bandwidth of the Ethernet interface is increased from 10 G to 100 G, the 64-byte fixed length packet forwarding rate within 1 second is increased to 150M.

From the above analysis, it can be seen that: along with great increase of the forwarding rate of the minimum data packet required to be processed by the switch access module, a forwarding rate of a cell sent to a switch fabric by the switch access module may also be greatly increased because a minimum data packet is usually encapsulated into a cell according to a solution of the related technology, and because the switch fabric is interconnected with multiple switch access modules, a cell forwarding rate of the switch fabric is also required to be greatly increased, that is, a number of cells required to be processed per second is greatly increased. Since the switch fabric is required to search for a corresponding switch access module number and corresponding high-speed serial link of each cell according to a destination address or multicast ID of the cell and forward the cell to the corresponding switch access module, along with great increase of the number of the cells required to be processed by the switch fabric per second, a design requirement on a searching capability and cache reading-writing capability of the switch fabric greatly increases, and it is further difficult to design and implement the switch fabric.

From the above, the related technology has the following problem: along with increase of a data forwarding rate, a cell forwarding rate of a switch fabric is greatly increased, which causes sharp increase of a requirement on a cell processing capability of the switch fabric and increases difficulties in designing of the switch fabric.

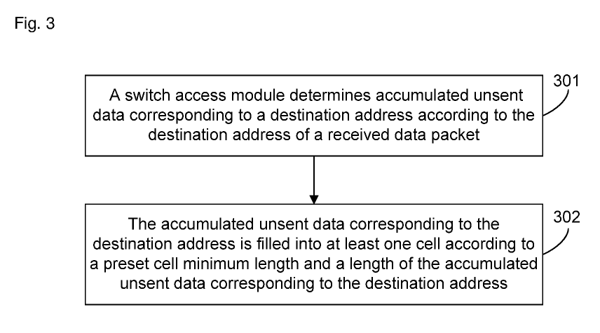

In view of this, an embodiment of the disclosure records a cell encapsulation method, which may be applied to a switch access module in a switching network system, the switch access module supports sending of a cell to a switch fabric, and the switch fabric sends the cell to a destination switch access module through a high-speed serial link. The switch access module encapsulates the cell by virtue of the cell encapsulation method recorded by this embodiment of the disclosure, and sends the cell to the switch fabric, so that a number of cells sent to the switch fabric by the switch access module may be reduced, and a cell forwarding rate of the switch fabric may further be reduced. As shown in FIG. 3, the cell encapsulation method recorded by this embodiment includes the following steps.

Step 301: a switch access module determines accumulated unsent data corresponding to a destination address according to the destination address of a received data packet.

Here, the accumulated unsent data corresponding to the destination address includes the data packet received by the switch access module and unsent data cached by the switch access module and corresponding to the destination address.

Step 302: the accumulated unsent data corresponding to the destination address is filled into at least one cell according to a preset cell minimum length and a length of the accumulated unsent data corresponding to the destination address.

As an implementation mode, the step that the accumulated unsent data corresponding to the destination address is filled into the at least one cell according to the preset cell minimum length and the length of the accumulated unsent data corresponding to the destination address includes that:

when the length of the accumulated unsent data corresponding to the destination address is greater than the cell minimum length, the accumulated unsent data corresponding to the destination address is filled into at least two cells until a length of left accumulated unsent data is zero or less than the cell minimum length, wherein lengths of the cells obtained after filling correspond to the cell minimum length.

A cell includes three parts: i.e. a destination address, a cell head and a cell payload. When the cells are encapsulated by virtue of the accumulated unsent data, the accumulated unsent data corresponding to the destination address is filled into cell payloads of the cells, the destination address of the accumulated unsent data is filled into destination addresses of the cells, and data volumes of data packets corresponding to the accumulated unsent data in the cell payloads and starting positions and lengths of the data packets in the cells are filled into the cell heads.

As an implementation mode, when the length of the left accumulated unsent data is less than the cell minimum length, the method further includes that: the left accumulated unsent data is cached as unsent data corresponding to the destination address; and a number of data packets corresponding to the left unsent data and a starting position and length of each data packet in a cache are stored. Therefore, when a data packet with the same destination address with the cached unsent data is subsequently received again, the unsent data corresponding to the destination address of the data packet may be extracted from the cache as accumulated unsent data corresponding to the destination address together with the received data packet, and a cell encapsulation operation may be performed by virtue of the cell minimum length, that is, the accumulated unsent data corresponding to the destination address of the data packet is filled into a cell. The implementation operation of cell filling has been described above, and will not be elaborated herein.

As an implementation mode, the step that the accumulated unsent data corresponding to the destination address is filled into the cell according to the preset cell minimum length and the length of the accumulated unsent data corresponding to the destination address includes that:

when the length of the accumulated unsent data corresponding to the destination address is less than the cell minimum length and a number of data packets corresponding to the accumulated unsent data corresponding to the destination address is greater than or equal to a minimum value of a number of data packets filled into the cell, the accumulated unsent data corresponding to the destination address is filled into one cell. Therefore, the condition that the data packets are encapsulated into multiple cells (for example, the condition that one data packet is encapsulated into one cell) may be avoided, a number of cells received by a switch fabric may be reduced, and a cell forwarding rate of the switch fabric is further reduced.

As an implementation mode, when the length of the accumulated unsent data corresponding to the destination address is less than the cell minimum length and the number of the data packets corresponding to the accumulated unsent data corresponding to the destination address is less than the minimum value of the number of the data packets filled into the cell, the accumulated unsent data corresponding to the destination address is cached as unsent data corresponding to the destination address; and starting positions and lengths of the data packets corresponding to the cached unsent data corresponding to the destination address in the cache are identified. Therefore, when a data packet with the same destination address with the cached unsent data is subsequently received again, the unsent data corresponding to the destination address of the data packet may be extracted from the cache as accumulated unsent data corresponding to the destination address together with the received data packet, and the cell encapsulation operation may be performed by virtue of the cell minimum length, that is, the accumulated unsent data corresponding to the destination address of the data packet is filled into a cell. An implementation operation of cell filling has been described above, and will not be elaborated herein.

As an implementation mode, before the step that the accumulated unsent data corresponding to the destination address is filled into the cell according to the preset cell minimum length and the length of the accumulated unsent data corresponding to the destination address, the method further includes that:

it is determined that a destination switch access module corresponding to the destination address supports a splicing function. During a practical application, information about whether the destination switch access module corresponding to the destination address supports the splicing function or not may be pre-stored, so that whether the destination switch module supports the splicing function or not may be determined by querying the destination address.

As an implementation mode, when it is determined that the destination switch access module corresponding to the destination address does not support the splicing function, the accumulated unsent data corresponding to the destination address may be filled into the cell, wherein a length of the cell obtained by filling is less than or equal to the cell minimum length. For example, when the length of the accumulated unsent data corresponding to the destination address is less than or equal to the cell minimum length, the accumulated unsent data corresponding to the destination address is filled into one cell; and when the length of the accumulated unsent data corresponding to the destination address is greater than the cell minimum length, the accumulated unsent data corresponding to the destination address is filled into at least two cells, wherein each cell is filled with one data packet (data packet corresponding to the accumulated unsent data corresponding to the destination address). Therefore, mixed insertion of switch access modules which support the splicing function and do not support the splicing function may be implemented, and a new switch access module which supports the splicing function may be butted with an old switch access module which does not support the splicing function to implement smooth transition of the new and old switch access modules.

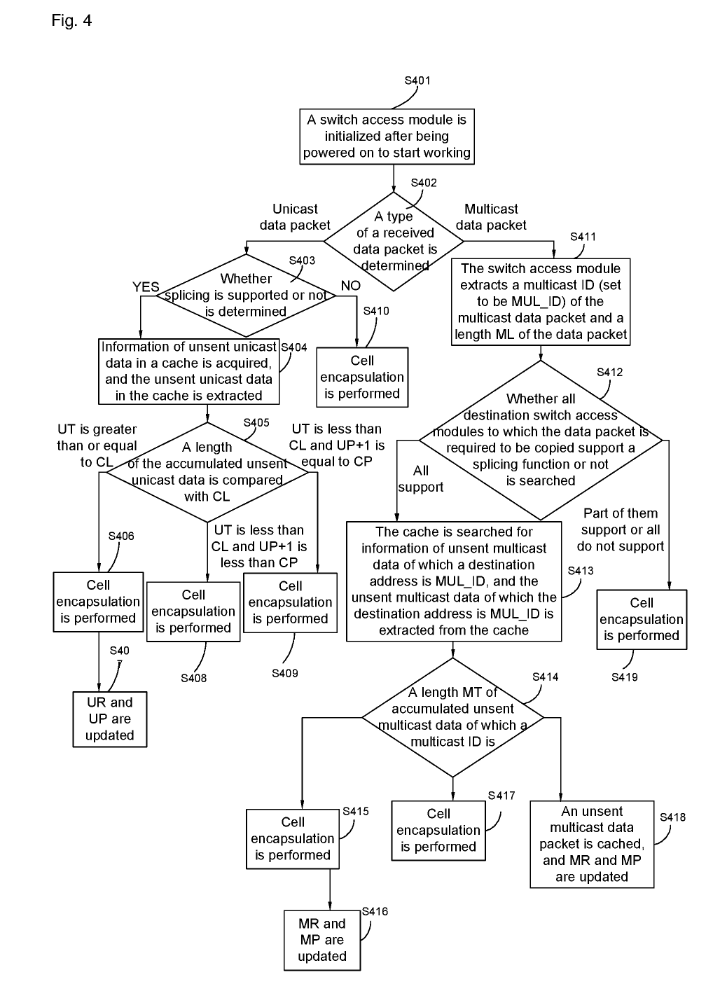

In a practical application scenario, data packets received by a switch access module include unicast data packets and multicast data packets. The cell encapsulation method recorded by the embodiments of the disclosure will be described below with reference to processing in case of reception of different types of data packets. A flow of the cell encapsulation method recorded by the embodiments of the disclosure, as shown in FIG. 4, includes the following steps.

Step S401: a switch access module is initialized after being powered on to start working.

For all switch access modules supporting unicast destination addresses in a switching network system, the switch access modules set IDs UR indicating byte numbers (i.e. lengths) of unsent unicast data in caches to be 0 to indicate that there exists no unsent unicast data in the caches, clear caches arranged to store the unsent unicast data, set IDs UP indicating number information of unsent unicast data packets to be 0, and clear IDs arranged to indicate a starting position of each unsent unicast data packet in the caches and IDs indicating a length of each unsent unicast data packet.

For a switch access module supporting a multicast ID in the switching network system, the switch access module sets an ID MR indicating a byte number of unsent multicast data in a cache to be 0, clears a cache arranged to store the unset multicast data, sets an ID MP indicating number information of unsent multicast data packets in the cache to be 0, and clears an ID arranged to indicate a starting position of each unsent multicast data packet in the cache in the cache and an ID indicating a length of each unsent data packet in the cache.

Subsequent steps will be described with processing in case of reception of one data packet, and processing in case of reception of multiple data packets is similar to the processing in case of reception of one data packet.

Step S402: a data packet is received, and a type of the received data packet is determined.

The switch access module receives a data packet from a packet processor module, and extracts type (unicast or multicast) information of the data packet; when it is a unicast data packet, step S403 is executed; and when it is a multicast data packet, step S411 is executed.

Step S403: whether splicing is supported or not is determined.

The switch access module extracts a unicast destination address DST_ID of the unicast data packet and a length UL of the data packet, and determines whether a destination switch access module supports a splicing function or not according to the unicast destination address; if YES, step S404 is executed, otherwise, step S410 is executed.

Step S404: information of unsent unicast data in a cache is acquired, and the unsent unicast data in the cache is extracted.

The switch access module searches for the following information according to the unicast destination address: a byte number UR of unsent unicast data of which a unicast destination address is DST_ID in the cache, number information UP of unsent unicast data packets of which unicast destination addresses are DST_ID, and starting positions and lengths of the unsent unicast data packets in the cache.

The unsent unicast data of which the unicast destination address is DST_ID is extracted from the cache.

Step S405: information of accumulated unsent unicast data of which a destination address is DST_ID is determined, and a length of the accumulated unsent unicast data is compared with CL.

A length (i.e. byte number) UL of the unicast data packet received in step S402 and a byte number UR of the unsent unicast data, extracted in step S404, of which the unicast destination address is DST_ID are added to obtain the length UT of the accumulated unsent unicast data of which the destination address is DST_ID.

Step S406 is executed when UT is greater than or equal to the cell minimum length CL preset by the switching network system, step S408 is executed when UT is less than CL and UP+1 is equal to CP, and step S409 is executed when UT is less than CL and UP+1 is less than CP, wherein CP is a maximum value of a number of data packets required to be encapsulated (i.e. filled) into a cell when a length of data packets encapsulated in the cell is less than CL.

Step S406: cell encapsulation is performed.

Information of three parts of the unicast data packet is required to be identified in the unicast cell, wherein a first part is the destination address (DST_ID), a second part is a cell head (CELL_HEAD), the cell head identifies a number of unicast data packets, encapsulated in the cell, of which destination addresses are DST_ID_1 and a starting position and length of each unicast data packet of which the destination address is DST_ID in the cell, and a third part is a cell payload (CELL_PLD), encapsulated with the unicast data packet of which the destination address is DST_ID.

When UT is greater than CL, it is identified that the accumulated unsent unicast data of which the destination address is DST_ID may be filled into at least one cell, and the accumulated unsent unicast data of which the destination address is DST_ID is utilized for cell encapsulation. At this moment,

1) when UR is equal to 0, it is indicated that there is no unsent unicast data with the same unicast destination address with the data packet received in step S402, the unicast data packet received in step S402 is filled into a cell, and a filling operation is repeated until UT is less than CL (that is, unsent unicast data left after cell filling is insufficient to fill a cell) or UT is equal to 0 (that is, the unicast data packet received in step S402 is right completely filled into the cell).

2) When UR is greater than 0, during cell encapsulation, the unicast data, extracted from the cache, of which the destination address is DST_ID is filled into the cell at first, and then the unicast data packet received in step S402 is filled into the cell until UT is less than CL (that is, the unsent unicast data left after cell filling is insufficient to fill a cell) or UT is equal to 0 (that is, the length of the unicast data packet received in step S402 is CL for right complete filling into the cell).

For example, the unsent unicast data, extracted from the cache, of which the destination address is DST_ID is filled into the cell at first, and after all the unsent unicast data, extracted from the cache, with DST_ID is filled into the cell, when the length of the data packets filled into the cell has yet not reached CL at this moment, the unicast data packet received in step S402 is filled until UT is less than CL or UT is equal to 0.

After filling is completed, it is also necessary to subtract CL from UT to obtain new UT to identify a length of accumulated unsent unicast data of which the destination address is DST_ID after cell filling is completed.

Step S407: UR and UP are updated.

When UT is greater than 0 after step S406 is executed, the following operation is executed: the unsent unicast data of which the destination address is DST_ID after step S406 is executed is stored back into the cache, a value of UT is assigned to UR, UP is set to be 1 (identifying that there is unsent unicast data of which the destination address is DST_ID in the cache), and a starting position and length of the unicast data of which the destination address is DST_ID in the cache in the cache are recorded.

When UT is equal to 0 after step S406 is executed, UP is set to be 0 (identifying that there is no unsent unicast data of which the destination address is DST_ID in the cache), and step S402 is executed.

Step S408: cell encapsulation is performed.

When UT is less than CL and UP+1 is equal to CP, it is indicated that a number of accumulated unsent unicast data packets of which destination addresses are DST_ID reaches a minimum value of the number of the data packets required to be filled into the cell when UT is less than CL, the accumulated unsent unicast data of which the destination address is DST_ID is filled into a payload of the cell, and encapsulation of CP unicast data packets of which destination addresses are DST_ID in the cell, a starting position of each data packet in the cell and a length of each data packet are identified in a cell head, and the cell is sent. At this moment, there is no unsent unicast data of which the destination address is DST_ID in the cache, and the unicast data packet received in step S402 also has been sent, so that UR and UP are set to be 0, and step S402 is executed.

Step S409: the received unicast data packet is cached, and a data packet is continued to be received.

When UT is less than CL and UP+1 is less than CP, it is indicated that the number of the accumulated unsent unicast data packets of which the destination addresses are DST_ID does not reach the minimum value of the number of the data packets required to be encapsulated into the cell when UT is less than CL, the unicast data packet received in step S402 and the extracted unsent unicast data are stored back into the cache together, UP+1 is assigned to CP, the starting positions and lengths of the unsent unicast data packets of which the destination addresses are DST_ID are recorded, a value of UR (the length of the cached unsent unicast data packets of which the destination addresses are DST_ID) is updated to be UT, and step S402 is executed.

Step S410: cell encapsulation is performed.

The destination switch access module does not support the splicing function.

When UT is less than or equal to CL, the current unicast data packet (received in step S402) is filled into a cell for sending to the destination switch access module, and that the cell includes only one unicast data packet and a starting position and length of the unicast data packet in the cell are indicated in a cell head.

When UT is greater than CL, the current unicast data packet (received in step S402) is filled into at least two cells of which lengths are less than or equal to CL, inclusion of only one data packet and the starting position and length of the unicast data packet in the cell are identified in a cell head of each cell, the cells obtained after filling are sequentially sent to the destination switch access module, and step S402 is executed.

Step S411: the switch access module extracts a multicast ID (set to be MUL_ID) of the multicast data packet and a length ML of the data packet.

Step S412: the switch access module searches for whether all destination switch access modules to which the data packet is required to be copied support a splicing function or not according to the multicast ID; when the destination switch access modules all do not support the splicing function or partially do not support the splicing function, step S419 is executed; and when the destination switch access modules to which the data packet is required to be copied all support the splicing function, step S413 is executed.

Step S413: the cache is searched for information of unsent multicast data of which a destination address (i.e. the multicast ID) is MUL_ID, and the unsent multicast data of which the destination address (i.e. the multicast ID) is MUL_ID is extracted from the cache.

The switch access module searches for the following information according to the multicast ID: a byte number MR of unsent multicast data of which a multicast ID is MUL_ID in the cache, a number MP of unsent multicast data packets of which multicast IDs are MUL_ID in the cache, and starting positions and lengths of the unsent multicast data packets of which the multicast IDs are MUL_ID in the cache. The unsent multicast data of which the multicast ID is MUL_ID is extracted from the cache.

Step S414: information of unsent multicast data packets of which multicast IDs are MUL_ID is updated, and a length MT of accumulated unsent multicast data of which a multicast ID is MUL_ID is compared with CL.

The length ML of the multicast data packet received in step S402 and the byte number MR of the unsent multicast data of which the multicast ID is MUL_ID in the cache are added to obtain the length MT of the accumulated unsent multicast data of which the multicast ID is MUL_ID.

Step S415 is executed when MT is greater than or equal to the cell minimum length CL preset in the switching network system.

Step S417 is executed when MT is less than CL and MP+1 is equal to CP.

Step S418 is executed when MT is less than CL and MP+1 is less than CP.

Step S415: when MT is greater than CL, the data packet is started to be encapsulated into a cell.

The multicast cell includes three parts of information, the first part is the multicast ID (MUL_ID), the second part is a cell head (CELL_HEAD), CELL-HEAD includes a number of multicast data packets encapsulated in the cell and a starting position and length of each multicast data packet in the cell, and the third part is a cell payload (CELL_PLD), encapsulated with the multicast data packets. During cell encapsulation,

when MR is equal to 0, it is indicated that there is no unsent multicast data with the same multicast address with the multicast data packet received in step S402, the multicast data packet received in step S402 is filled into a cell, and the filling operation is repeated until MT is less than CL (that is, multicast data left after the multicast data packet received in step S402 is filled into the cell is insufficient to fill a cell) or MT is equal to 0 (that is, the multicast data packet received in step S402 is right completely filled into the cell).

When MR is greater than 0, during cell encapsulation, the unsent multicast data, extracted from the cache, of which the multicast ID is MUL_ID is filled into the cell at first, and then the multicast data packet received in step S402 is filled into the cell until MT is less than CL (that is, the multicast data left after the multicast data packet is filled into the cell is insufficient to fill a cell) or MT is equal to 0 (that is, the multicast data packet is right completely filled into the cell). Information (including a number of multicast data packets of which multicast IDs are MUL_ID and starting addresses and lengths in the cell) of the multicast data packets encapsulated into the cell is required to be identified in a cell head of the cell.

After cell encapsulation is performed, it is also necessary to subtract CL from MT to obtain new MT to identify a length of accumulated unsent multicast data of which the multicast ID is MUL_ID after cell filling is completed.

Step S416: MR and MP are updated.

A value of MT is assigned to MR.

Regarding MP,

when MT is greater than 0 after step S415 is executed, the accumulated unsent multicast data of which the multicast ID is MUL_ID after step S415 is executed is stored back into the cache, MP is set to be 1 (identifying that there is unsent multicast data of which the multicast ID is MUL_ID in the cache), and starting positions and lengths of the unsent multicast data packets of which the multicast IDs are MUL_ID in the cache are recorded.

When MT is equal to 0 after step S415 is executed, it is indicated that there is no unsent multicast data packet, and MP is set to be 0, and

Step S402 is executed.

Step S417: cell encapsulation is performed.

When MT is less than CL and MP+1 is equal to CP, it is indicated that a number of accumulated unsent multicast data packets of which multicast IDs are MUL_ID reaches a minimum value of the number of the data packets required to be filled into the cell when MT is less than CL, the accumulated unsent multicast data of which the multicast ID is MUL_ID is filled into a cell, filling of CP data packets is identified in the cell, and a starting position and length of each filled data packet in the cell are identified in a cell head.

At this moment, there is no accumulated unsent multicast data packet of which the multicast ID is MUL_ID, so that MR and MP are set to be 0, and Step S402 is executed.

Step S418: an unsent multicast data packet is cached, and MR and MP are updated.

When MT is less than CL and MP+1 is less than CP, it is indicated that the number of the accumulated unsent multicast data packets of which the multicast IDs are MUL_ID does not reach the minimum value CP of the number of the data packets required to be encapsulated into the cell when MT is less than CL, cell encapsulation is not performed and sent, the accumulated unsent multicast data of which the multicast ID is MUL_ID is stored back into the cache, MT is assigned to MR (the length of the unsent multicast data of which the multicast ID is MUL_ID in the cache is updated), MP+1 is assigned to MP (the number of the unsent multicast data packets of which the multicast IDs are MUL_ID in the cache is updated), starting positions and lengths of MP multicast data packets of which multicast IDs are MUL_ID in the cache in the cache are recorded, and Step S402 is executed.

Step S419: cell encapsulation is performed.

Part of destination switch access modules of the multicast data packet corresponding to the multicast ID or all the switch access modules do not support the splicing function.

When MT is less than or equal to CL, the current multicast data packet (received in step S402) is filled into a cell to be sent to a destination switch access module, and that the cell includes only one data packet and a starting position and length of the multicast data packet in the cell are indicated in a cell head CLL_HEAD.

When MT is greater than CL, the current multicast data (received in step S402) is filled into at least two cells of which lengths are less than or equal to CL, filling of only one multicast data packet in the cell and the starting position and length of the multicast data packet in the cell are identified in a cell head CELL_HEAD of each cell, the cells obtained after filling are sent to the destination switch access module, and step S402 is executed.

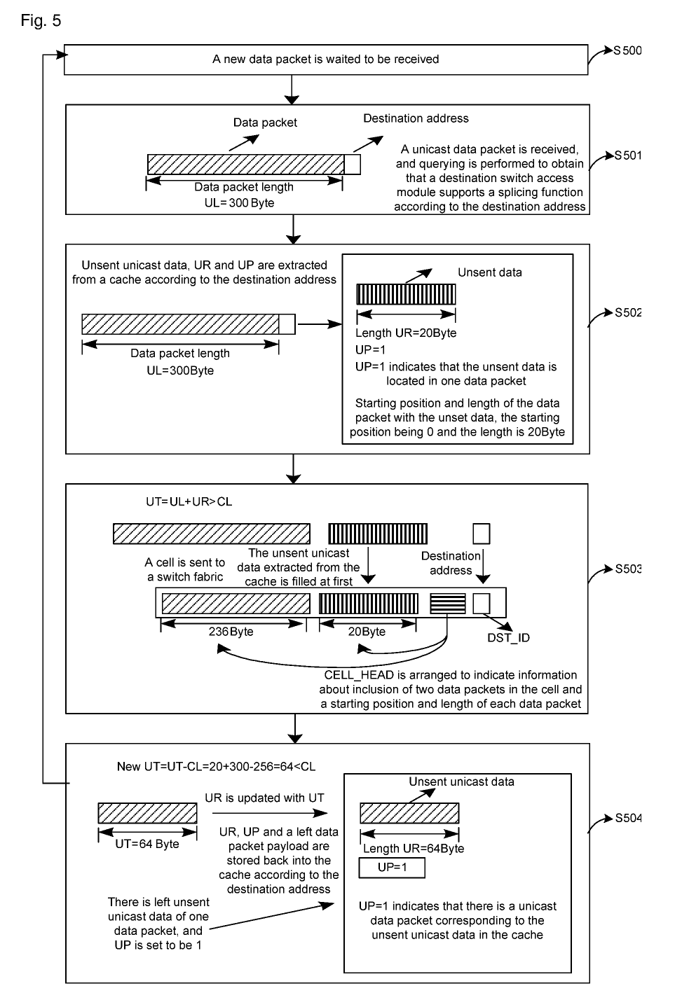

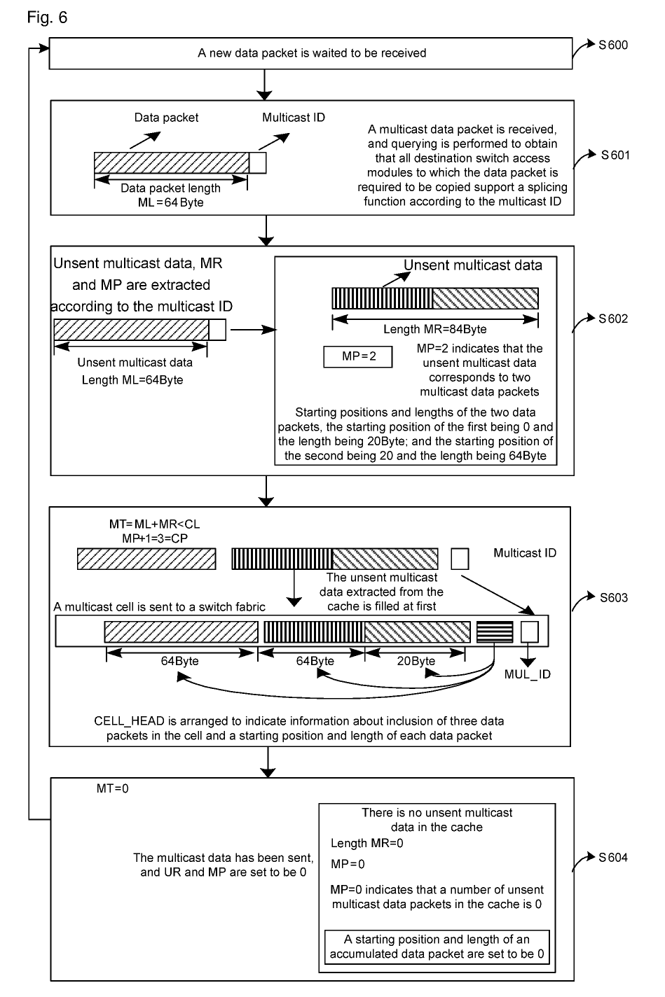

FIG. 5 and FIG. 6 are implementation flow charts of implementation of cell encapsulation in two scenarios according to embodiments of the disclosure. In such an application, a minimum data packet received by a switching interface is 64 Byte, CL is arranged to be 256 bytes, and CP is arranged to be 3.

An application scenario corresponding to FIG. 5 is described below.

Step S500: a switch access module waits for a new data packet.

Step S501: the switch access module receives a unicast data packet, extracts a destination address and data packet length included in the unicast data packet, wherein the data packet length is 300 Byte, that is, UL is equal to 300 Byte, and simultaneously performs querying to obtain that a destination switch access module supports a splicing function according to the destination address.

Step S502: unsent unicast data in a cache, UR and UP are extracted according to the destination address, wherein UR is 20 Byte and UP is 1, which indicate that there is 20 Byte unsent data of one data packet corresponding to the destination address in the cache, and information arranged to indicate a starting position and length of a data packet with the unsent data in the cache is also read.

Step S503: UT is equal to a sum of UL and UR, and is equal to 320 Byte greater than CL, so that 256 Byte data therein is encapsulated into a cell, the cell including three parts of contents, a destination address DST_ID being a destination switch access module, a cell head CELL_HEAD indicating encapsulation of two data packets and starting positions and lengths of the two data packets in the cell, and a cell payload (CELL_PLD) containing the two data packets.

During cell encapsulation, the unsent unicast data extracted from the cache is filled into the cell payload at first, and then the data packet received in step S501 is filled.

Step S504: 256 Byte is subtracted from UT to obtain 64 Byte as new UT which identifies a byte number of accumulated unsent unicast data, and since new UT is less than CL, the left 64 Byte is stored back into the cache, a cache space is searched according to the destination address, the 64 Byte unicast data is cached, UR is set to be 64 Byte, UP is set to be 1 to indicate that there is a unicast data packet whose data has yet not been sent in the cache, the information about the starting position and length of the data packet with the unsent unicast data in the cache is simultaneously updated, and step S500 is executed.

An application scenario corresponding to FIG. 6 is described below.

Step S600: a switch access module waits for a new data packet.

Step S601: the switch access module receives a multicast data packet, extracts a multicast ID and data packet length included in the multicast data packet, the data packet length being 64 Byte, that is, ML being equal to 64 Byte, and simultaneously performs querying to obtain that all destination switch access module to which a multicast cell is required to be copied support a splicing function according to the multicast ID.

Step S602: unsent multicast data corresponding to the multicast ID in a cache, MR and MP are extracted according to the multicast ID, MR being 84 Byte and MP being 2, which indicate that there are two data packets including totally 84 Byte unsent multicast data corresponding to the multicast ID, and information arranged to indicate a starting position and length of a multicast data packet with the unsent multicast data in the cache is read.

Step S603: MT is equal to a sum of ML and MR, and is equal to 148 Byte less than CL, but MP+1 is equal to 3 and reaches the parameter CP set in the switching network system, which indicates that a minimum value of a number of data packets required to be encapsulated in a cell when MT is less than CL has been reached, so that the 148 Byte data is totally encapsulated into a cell, the cell including three parts of contents and a destination address MUL_ID being the multicast ID, and the cell is sent to a switch fabric for multicast cell copying, a cell head CELL_HEAD indicating encapsulation of data of three data packets and starting positions and lengths of the three data packets in the cell, and a cell payload (CELL_PLD) containing the three data packets.

As shown in FIG. 6, when cell encapsulation is performed, the totally 84 Byte unsent multicast data of which the destination address is MUL_ID in the cache is filled into the cell at first, and then the data packet received in step S601 is filled into the cell.

Step S604: an updated value of MT is equal to 0, which indicates that there is no accumulated unsent multicast data packet corresponding to the multicast ID, so that MR and MP are set to be 0, the information about the starting position and length of the multicast data packet with the unsent multicast data in the cache is set to be 0, and step S600 is executed.

In the application scenarios shown in FIG. 5 and FIG. 6, the switch access module assembles most of data packets in cells of greater than 64 Byte in a splicing manner, so that a cell forwarding rate is reduced, and difficulties in designing of the switch fabric are reduced.

Detailed descriptions about other scenarios to which the technical solutions recorded by the embodiments of the disclosure are applied have been made before, and will not be described herein with examples one by one.

The embodiments of the disclosure further record a computer storage medium, in which a computer-executable instruction is stored, the computer-executable instruction being arranged to execute a cell encapsulation processing flow shown in FIG. 3 or FIG. 4.

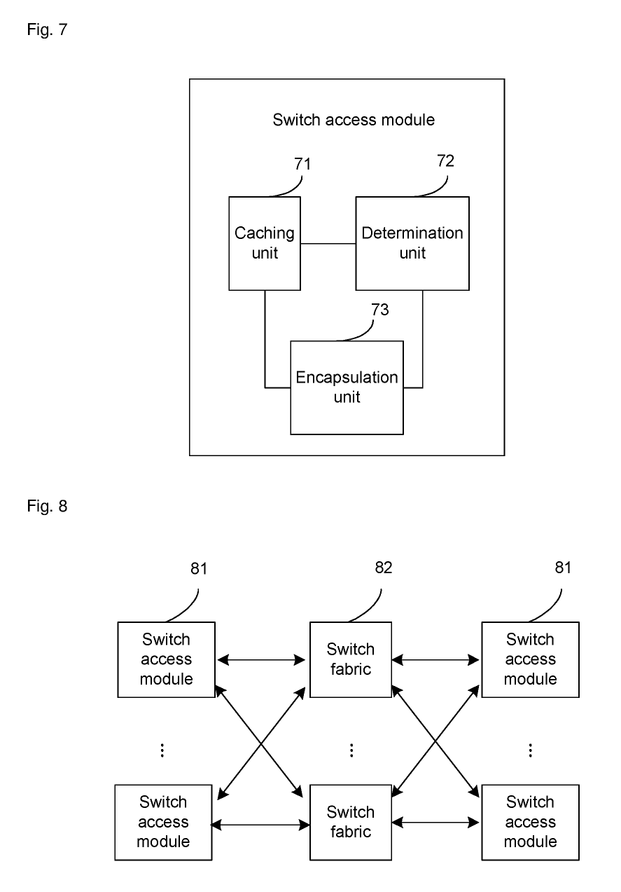

Embodiments of the disclosure further record a switch access module, which may be applied to a switching network system shown in FIG. 2. The switch access module supports sending of a cell to a switch fabric, and the switch fabric sends the cell to a destination switch access module through a high-speed serial link. The switch access module encapsulates the cell, and sends the cell to the switch fabric, so that a number of cells sent to the switch fabric by the switch access module may be reduced, and a cell forwarding rate of the switch fabric may further be reduced. As shown in FIG. 7, the switch access module recorded by the embodiments includes:

a caching unit 71, arranged to cache unsent data;

a determination unit 72, arranged to determine accumulated unsent data corresponding to a destination address according to the destination address of a received data packet, wherein the accumulated unsent data corresponding to the destination address includes the data packet received by the switch access module and unsent data cached by the caching unit 71 and corresponding to the destination address; and

an encapsulation unit 73, arranged to fill the accumulated unsent data corresponding to the destination address into at least one cell according to a preset cell minimum length and a length of the accumulated unsent data corresponding to the destination address.

As an implementation mode, the encapsulation unit 73 is further arranged to, when the length of the accumulated unsent data corresponding to the destination address is greater than the cell minimum length, fill the accumulated unsent data corresponding to the destination address into at least two cells until a length of left accumulated unsent data is zero or less than the cell minimum length, wherein

lengths of the cells obtained after filling correspond to the cell minimum length.

As an implementation mode, the caching unit 71 is further arranged to, when the length of the left accumulated unsent data is less than the cell minimum length, cache the left accumulated unsent data; and

the encapsulation unit 73 is further arranged to store starting positions and lengths of data packets corresponding to the left unsent data in a cache.

As an implementation mode, the encapsulation unit 73 is further arranged to, when the length of the accumulated unsent data corresponding to the destination address is less than the cell minimum length and a number of data packets corresponding to the accumulated unsent data corresponding to the destination address is greater than or equal to a minimum value of a number of data packets filled into the cell, fill the accumulated unsent data corresponding to the destination address into one cell.

As an implementation mode, the encapsulation unit 73 is further arranged to, when the length of the accumulated unsent data corresponding to the destination address is less than the cell minimum length and the number of the data packets corresponding to the accumulated unsent data corresponding to the destination address is less than the minimum value of the number of the data packets filled into the cell, cache the accumulated unsent data, and identify starting positions and lengths of the data packets corresponding to the accumulated unsent data in the cache.

As an implementation mode, the determination unit 72 is further arranged to, when it is determined that a destination switch access module corresponding to the destination address supports a splicing function, trigger the encapsulation unit 73 to fill the accumulated unsent data into the cell according to the preset cell minimum length and the length of the accumulated unsent data.

As an implementation mode, the determination unit 72 is further arranged to, when it is determined that the destination switch access module corresponding to the destination address does not support the splicing function, trigger the encapsulation unit 73 to fill the accumulated unsent data corresponding to the destination address into the cell, wherein a length of the cell obtained by filling is less than or equal to the cell minimum length.

As an implementation mode, the encapsulation unit 73 is further arranged to, when the length of the accumulated unsent data corresponding to the destination address is less than or equal to the cell minimum length, fill the accumulated unsent data corresponding to the destination address into one cell; and

when the length of the accumulated unsent data is greater than the cell minimum length, fill the accumulated unsent data corresponding to the destination address into at least two cells.

The switch access module in the switching network system may be implemented by an Application Specific Integrated Circuit (ASIC) chip or an FPGA chip; correspondingly, the caching unit 71 may be implemented by a dynamic cache or a static cache; and the determination unit 72 and the encapsulation unit 73 are function modules in the ASIC or FPGA chip.

Embodiments of the disclosure further record a switching network system. As shown in FIG. 8, the switching network system includes:

switch access modules 81 and switch fabrics 82, wherein

each switch access module 81 is arranged to determine accumulated unsent data corresponding to a destination address according to the destination address of a received data packet, wherein the accumulated unsent data corresponding to the destination address includes the data packet received by the switch access module 81 and unsent data cached by the switch access module 81 and corresponding to the destination address;

each switch access module 81 is arranged to fill the accumulated unsent data corresponding to the destination address into at least one cell according to a preset cell minimum length and a length of the accumulated unsent data corresponding to the destination address; and

the switch fabrics 82 are arranged to receive the cells sent by the switch access modules 81, and send the cells to destination switch access modules 81 according to the destination addresses of the cells.

As an implementation mode, each switch access module 81 is further arranged to, when the length of the accumulated unsent data corresponding to the destination address is greater than the cell minimum length, fill the accumulated unsent data corresponding to the destination address into at least two cells until a length of left accumulated unsent data is zero or less than the cell minimum length, wherein lengths of the cells obtained after filling correspond to the cell minimum length.

As an implementation mode, each switch access module 81 is further arranged to, when the length of the left accumulated unsent data is less than the cell minimum length, cache the left accumulated unsent data, and store starting positions and lengths of data packets corresponding to the left unsent data in a cache.

As an implementation mode, each switch access module 81 is further arranged to, when the length of the accumulated unsent data corresponding to the destination address is less than the cell minimum length and a number of data packets corresponding to the accumulated unsent data corresponding to the destination address is greater than or equal to a minimum value of a number of data packets filled into the cell, fill the accumulated unsent data corresponding to the destination address into one cell.

As an implementation mode, each switch access module 81 is further arranged to cache the accumulated unsent data, and identify starting positions and lengths of the data packets corresponding to the accumulated unsent data in the cache.

As an implementation mode, each switch access module 81 is further arranged to, before filling the accumulated unsent data into the at least one cell according to the preset cell minimum length and the length of the accumulated unsent data, determine that a destination switch access module corresponding to the destination address supports a splicing function.

As an implementation mode, each switch access module 81 is further arranged to, when it is determined that the destination switch access module corresponding to the destination address does not support the splicing function, fill the accumulated unsent data corresponding to the destination address into the cell, wherein a length of the cell obtained by filling is less than or equal to the cell minimum length.

As an implementation mode, each switch access module 81 is further arranged to, when the length of the accumulated unsent data corresponding to the destination address is less than or equal to the cell minimum length, fill the accumulated unsent data corresponding to the destination address into one cell; and

when the length of the accumulated unsent data is greater than the cell minimum length, fill the accumulated unsent data corresponding to the destination address into at least two cells.

In a data network communication product, the switch access modules and the switch fabrics are correspondingly implemented by independent chips (based on ASIC or FPGA).

From the above, in the embodiments of the disclosure, the switch access module may assemble multiple data packets in a cell in a splicing manner, so that a cell forwarding rate is reduced, and difficulties in designing of the switch fabric is reduced. In addition, according to the embodiments of the disclosure, whether the destination switch access module has a message splicing function or not may further be determined according to the destination address and the multicast ID, so that mixed insertion of switch access modules which support the splicing function and do not support the splicing function may be implemented, and a new switch access module which supports the splicing function may be butted with an old switch access module which does not support the splicing function to implement smooth transition of the new and old switch access modules.

Those skilled in the art should know that: all or part of the steps in the abovementioned method embodiments may be implemented by instructing related hardware through a program, the abovementioned program may be stored in a computer-readable storage medium, and the program is executed to execute the steps of the abovementioned method embodiments; and the storage medium includes: various media capable of storing program codes such as a mobile storage device, a Random Access Memory (RAM), a Read-Only Memory (ROM), a magnetic disk, an optical disk or the like.

Or, when being implemented in form of software function device and sold or used as an independent product, the integrated unit of the disclosure may also be stored in a computer-readable storage medium. Based on such an understanding, the technical solutions of the embodiments of the disclosure substantially or parts making contributions to the related technology may be embodied in form of software product, and the computer software product is stored in a storage medium, including a plurality of instructions arranged to enable a computer device (which may be a personal computer, a server, a network device or the like) to execute all or part of the method in each embodiment of the disclosure. The abovementioned storage medium includes: various media capable of storing program codes such as a mobile storage device, RAM, a ROM, a magnetic disk, an optical disk or the like.

The above are only specific implementation modes of the disclosure and not intended to limit the scope of protection of the disclosure. Any variations or replacements apparent to those skilled in the art within the technical scope disclosed by the disclosure shall fall within the scope of protection of the disclosure. Therefore, the scope of protection of the disclosure shall be subject to the scope of protection of the claims.

1. A cell encapsulation method, comprising:
determining, by a switch access module, accumulated unsent data corresponding to a destination address according to the destination address of a received data packet, wherein the accumulated unsent data corresponding to the destination address contains the data packet received by the switch access module and unsent data cached by the switch access module and corresponding to the destination address; and
filling the accumulated unsent data corresponding to the destination address into at least one cell according to a preset cell minimum length and a length of the accumulated unsent data corresponding to the destination address.

2. The method according to claim 1, wherein the step of filling the accumulated unsent data corresponding to the destination address into the at least one cell according to the preset cell minimum length and the length of the accumulated unsent data corresponding to the destination address comprises:
when the length of the accumulated unsent data corresponding to the destination address is greater than the cell minimum length, filling the accumulated unsent data corresponding to the destination address into at least two cells until a length of left accumulated unsent data is zero or less than the cell minimum length, wherein
lengths of the cells obtained after filling correspond to the cell minimum length.

3. The method according to claim 2, further comprising: when the length of the left accumulated unsent data is less than the cell minimum length,
caching the left accumulated unsent data; and
storing starting positions and lengths of data packets corresponding to the left unsent data in a cache.

4. The method according to claim 1, wherein the step of filling the accumulated unsent data corresponding to the destination address into the at least one cell according to the preset cell minimum length and the length of the accumulated unsent data corresponding to the destination address comprises:
when the length of the accumulated unsent data corresponding to the destination address is less than the cell minimum length and a number of data packets corresponding to the accumulated unsent data corresponding to the destination address is greater than or equal to a minimum value of a number of data packets filled into the cell, filling the accumulated unsent data corresponding to the destination address into one cell.

5. The method according to claim 4, further comprising: when the length of the accumulated unsent data corresponding to the destination address is less than the cell minimum length and the number of the data packets corresponding to the accumulated unsent data corresponding to the destination address is less than the minimum value of the number of the data packets filled into the cell,
caching the accumulated unsent data, and identifying starting positions and lengths of the data packets corresponding to the accumulated unsent data in a cache.

6. The method according to claim 1, further comprising: before filling the accumulated unsent data corresponding to the destination address into the at least one cell according to the preset cell minimum length and the length of the accumulated unsent data,
determining that a destination switch access module corresponding to the destination address supports a splicing function.

7. The method according to claim 6, further comprising: when it is determined that the destination switch access module corresponding to the destination address does not support the splicing function,
filling the accumulated unsent data corresponding to the destination address into the cell, wherein a length of the cell obtained by filling is less than or equal to the cell minimum length.

8. The method according to claim 7, wherein the step of filling the accumulated unsent data corresponding to the destination address into the cell comprises:
when the length of the accumulated unsent data corresponding to the destination address is less than or equal to the cell minimum length, filling the accumulated unsent data corresponding to the destination address into one cell; and
when the length of the accumulated unsent data is greater than the cell minimum length, filling the accumulated unsent data corresponding to the destination address into at least two cells.

9. A communication device, comprising:
a processor; and
a memory for storing instructions executable by the processor;
wherein the processor is arranged to:
cache unsent data;
determine accumulated unsent data corresponding to a destination address according to the destination address of a received data packet, wherein the accumulated unsent data corresponding to the destination address contains the data packet received by the communication device and the cached unsent data and corresponding to the destination address; and
fill the accumulated unsent data corresponding to the destination address into at least one cell according to a preset cell minimum length and a length of the accumulated unsent data corresponding to the destination address.

10. The communication device according to claim 9, wherein
the processor is further arranged to, when the length of the accumulated unsent data corresponding to the destination address is greater than the cell minimum length, fill the accumulated unsent data corresponding to the destination address into at least two cells until a length of left accumulated unsent data is zero or less than the cell minimum length, wherein
lengths of the cells obtained after filling correspond to the cell minimum length.

11. The communication device according to claim 10, wherein
the processor is further arranged to, when the length of the left accumulated unsent data is less than the cell minimum length, cache the left accumulated unsent data; and
the processor is further arranged to store starting positions and lengths of data packets corresponding to the left unsent data in a cache.

12. The communication device according to claim 9, wherein
the processor is further arranged to, when the length of the accumulated unsent data corresponding to the destination address is less than the cell minimum length and a number of data packets corresponding to the accumulated unsent data corresponding to the destination address is greater than or equal to a minimum value of a number of data packets filled into the cell, fill the accumulated unsent data corresponding to the destination address into one cell.

13. The communication device according to claim 12, wherein
the processor is further arranged to, when the length of the accumulated unsent data corresponding to the destination address is less than the cell minimum length and the number of the data packets corresponding to the accumulated unsent data corresponding to the destination address is less than the minimum value of the number of the data packets filled into the cell, cache the accumulated unsent data, and identify starting positions and lengths of the data packets corresponding to the accumulated unsent data in the cache.

14. The communication device according to claim 9, wherein
the processor is further arranged to, when it is determined that a destination communication device corresponding to the destination address supports a splicing function, fill the accumulated unsent data into the cell according to the preset cell minimum length and the length of the accumulated unsent data.

15. The communication device according to claim 14, wherein
the processor is further arranged to, when it is determined that the destination communication device corresponding to the destination address does not support the splicing function, fill the accumulated unsent data corresponding to the destination address into the cell, wherein a length of the cell obtained by filling is less than or equal to the cell minimum length.

16. The communication device according to claim 15, wherein
the processor is further arranged to, when the length of the accumulated unsent data corresponding to the destination address is less than or equal to the cell minimum length, fill the accumulated unsent data corresponding to the destination address into one cell; and
when the length of the accumulated unsent data is greater than the cell minimum length, fill the accumulated unsent data corresponding to the destination address into at least two cells.

17. (canceled)

18. A non-transitory computer storage medium, in which a computer-executable instruction is stored, the computer-executable instruction being arranged to perform a cell encapsulation method, comprising:
determining, by a communication device, accumulated unsent data corresponding to a destination address according to the destination address of a received data packet, wherein the accumulated unsent data corresponding to the destination address contains the data packet received by the communication device and unsent data cached by the communication device and corresponding to the destination address; and
filling the accumulated unsent data corresponding to the destination address into at least one cell according to a preset cell minimum length and a length of the accumulated unsent data corresponding to the destination address.

19. The non-transitory computer storage medium according to claim 18, wherein the step of filling the accumulated unsent data corresponding to the destination address into the at least one cell according to the preset cell minimum length and the length of the accumulated unsent data corresponding to the destination address comprises:
when the length of the accumulated unsent data corresponding to the destination address is greater than the cell minimum length, filling the accumulated unsent data corresponding to the destination address into at least two cells until a length of left accumulated unsent data is zero or less than the cell minimum length, wherein
lengths of the cells obtained after filling correspond to the cell minimum length.

20. The non-transitory computer storage medium according to claim 19, further comprising: when the length of the left accumulated unsent data is less than the cell minimum length,
caching the left accumulated unsent data; and
storing starting positions and lengths of data packets corresponding to the left unsent data in a cache.

21. The non-transitory computer storage medium according to claim 18, wherein the step of filling the accumulated unsent data corresponding to the destination address into the at least one cell according to the preset cell minimum length and the length of the accumulated unsent data corresponding to the destination address comprises:
when the length of the accumulated unsent data corresponding to the destination address is less than the cell minimum length and a number of data packets corresponding to the accumulated unsent data corresponding to the destination address is greater than or equal to a minimum value of a number of data packets filled into the cell, filling the accumulated unsent data corresponding to the destination address into one cell.

22. The non-transitory computer storage medium according to claim 21, further comprising: when the length of the accumulated unsent data corresponding to the destination address is less than the cell minimum length and the number of the data packets corresponding to the accumulated unsent data corresponding to the destination address is less than the minimum value of the number of the data packets filled into the cell,
caching the accumulated unsent data, and identifying starting positions and lengths of the data packets corresponding to the accumulated unsent data in a cache.

23. The non-transitory computer storage medium according to claim 18, further comprising: before filling the accumulated unsent data corresponding to the destination address into the at least one cell according to the preset cell minimum length and the length of the accumulated unsent data,
determining that a destination switch access module corresponding to the destination address supports a splicing function.

24. The non-transitory computer storage medium according to claim 23, further comprising: when it is determined that the destination switch access module corresponding to the destination address does not support the splicing function,
filling the accumulated unsent data corresponding to the destination address into the cell, wherein a length of the cell obtained by filling is less than or equal to the cell minimum length.

25. The non-transitory computer storage medium according to claim 24, wherein the step of filling the accumulated unsent data corresponding to the destination address into the cell comprises:
when the length of the accumulated unsent data corresponding to the destination address is less than or equal to the cell minimum length, filling the accumulated unsent data corresponding to the destination address into one cell; and
when the length of the accumulated unsent data is greater than the cell minimum length, filling the accumulated unsent data corresponding to the destination address into at least two cells.
